(19) United States
(12) Patent Application Publication
(10) Pub. No.: US 2026/0266356 A1
(43) Pub. Date: Sep. 10, 2026

(54) WELDED CHAIN LINK WITH INNER SEAL

(71) Applicant: REXNORD BRASIL SISTEMAS DE TRANSMISSÃO E MOVIMENTAÇÃO LTDA., São Leopoldo (BR)

(72) Inventors: Douglas Kohler Velasque Farias, São Leopoldo (BR); Martin Müller, Dois Irmãos (BR)

(21) Appl. No.: 19/161,708

(22) PCT Filed: Mar. 1, 2024
(86) PCT No.: PCT/BR2024/050076

§ 371 Date: Sep. 2, 2025

(30) Foreign Application Priority Data
Mar. 3, 2023 (BR) 102023004041-1

(51) Int. Cl. F16G 15/12

(52) U.S. Cl. CPC F16G 15/12

(57) ABSTRACT

The welded chain link with inner seal of the invention comprises two plates (1) with holes (1-A) and (1-B) at their ends, where next to the hole (1-A), on the inner side of the plate (1), a 5-sealing ring (2) is applied and a hollow bushing (3) is welded that contains an internal hole (3-A) complementary to the hole (1-A), allowing the insertion of the pin (4) for mounting another link in the chain assembly.

### TECHNICAL SECTOR

The present invention belongs to the technological sector of transport and material handling, more specifically it refers to a welded chain link with inner seal that comprises two plates interconnected to each other through a bushing welded at its ends next to each of the plates, with a sealing ring between the plate and the bushing ensuring lubrication retention and protection of the mechanism. This link has holes at the opposite end of the plate bushing, through which a pin is inserted connecting one link to the other and forming a welded chain for transporting materials.

### STATE OF THE ART

With the need to transport and lift materials for the most varied purposes, chains were developed. An element formed by interconnected links, which allow the transport of loads. Currently consisting mostly of links of steel alloy material, the chains have great mechanical resistance, enabling the transport of high weight materials. Such chain links are commonly formed by rolled steel bars, where one link is bent into the interior of the other, interconnecting them and forming the chain. One drawback of adopting this type of chain is the use of only one material in the link, limiting its strength and versatility.

Due to the increased demand for transporting large and heavy materials, especially in the area of pulp and paper, in particular the transport of wood, it was necessary to develop chains with a high tensile and wear resistance. For this, welded chains were developed, formed by plates, bushing and pin welded together, allowing each part of the link to contain the necessary dimensions and be improved according to the function it performs.

The patent document CN 202296145 describes a welded chain comprising links formed by two plates welded together, through a bushing can where a pin passes that connects one link to the other. These links receive a tempering treatment to increase their strength. A limitation of this type of chain is that its links do not contain a seal between the pin and the bushing, thus allowing the inlet of unwanted particles and outlet of lubrication. Thus, lubrication of the link joint is not guaranteed. The patent document U.S. Pat. No. 4,424,050 describes a roller chain with a seal that comprises links formed by four plates, two external and two internal interconnected by two rollers with bushings and pins inside that interconnect the plates of the same link and other links with each other. The link has a seal between the bushing and plates, on the outside of the bushing, through an elastic ring. This chain has the limitation of not being a welded chain, presenting a limited tensile strength.

### Novelties and Objective of the Invention

The objective of the present invention is a welded chain link with inner sealing for material transport that effectively solves the limitations of the previously mentioned state of the art.

The welded chain link with inner seal comprises two plates welded together through a bushing with an internal hole through which the interconnecting pin between links passes. In the region between the pin, bushing and plate, a metal sealing ring is applied, internally to the weld, ensuring the maintenance of lubrication on the pin and preventing the inlet of unwanted particles.

The possibility of lubrication of the link joint ensures that the material transport service is carried out more efficiently and with a lower maintenance cost.

Optionally, the link contains heat treatment on its components to increase its strength.

### Advantages and Technical Effects of the Invention

The welded chain link with inner sealing, object of the present invention, results in the following advantages and achieves the following technical effects over the welded chains of the state of the art:
State-of-the-art welded chains feature links without sealing in the internal space between the pin and the bushing, allowing the lubricating grease to move and exit the inside of the bushing or allowing the inlet of unwanted particles. Solved by the present invention through the application of a sealing ring between the pin and the bushing that ensures the maintenance of the lubricating grease next to the pin and prevents the inlet of unwanted particles;
The inner seal is through an expansive metal ring with high resistance to abrasive particles, hydrolysis, wear resistance and resistance to high contact pressure; and
The inner seal of the welded chain ensures a longer lifespan for the links, providing better operation with less friction and less wear.

### LIST OF ACCOMPANYING DRAWINGS

In order for this invention to be fully understood and put into practice by any person skilled in this technological field, it is now described in a clear, precise and sufficient manner, based on the accompanying drawings, listed below, which illustrate the preferred ways of carrying out the links of the welded chain:

FIG. 1—perspective view of the welded chain link;

FIG. 2—exploded perspective view of the welded chain link;

FIG. 3—top view of the welded chain link;

FIG. 4—perspective view of the isolated bushing;

FIG. 5—enlarged perspective sectional view of the inner seal of the link;

FIG. 6—enlarged cut-out top view of the inner link seal; and

FIG. 7—cut-out top view with illustration of the link weld points.

### DETAILED DESCRIPTION OF THE INVENTION

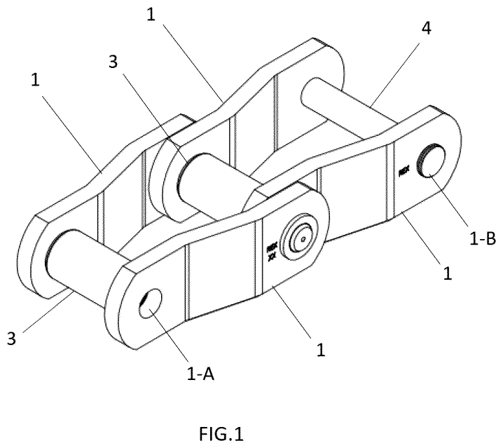

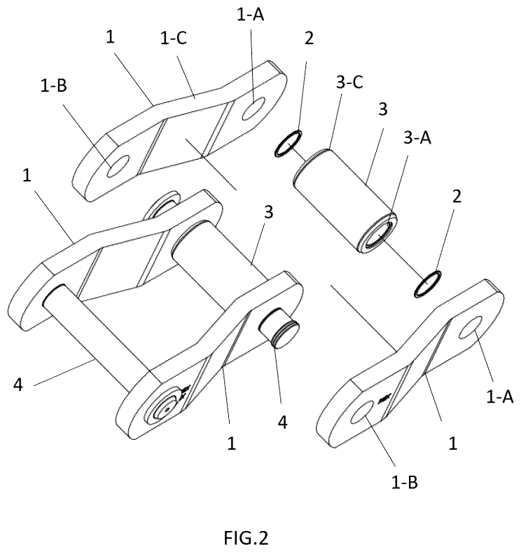

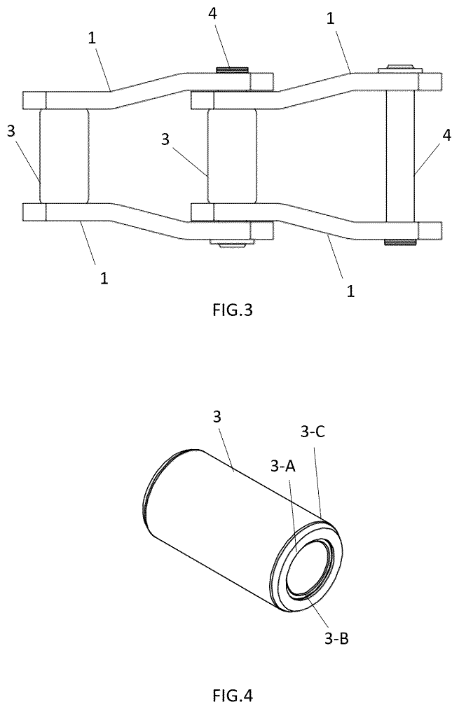

FIGS. 1 to 3 illustrate a welded chain with links comprising two plates (1) with holes (1-A) and (1-B) at their ends, where next to the hole (1-A), on the inner side of the plate (1), a sealing ring (2) is applied and a hollow bushing (3) is welded that contains an internal hole (3-A) complementary to the hole (1-A), allowing the insertion of the pin (4) for mounting another link in the chain assembly.

The plates (1) contain a body (1-C) with a curved shape that makes the holes (1-A), of two distinct plates, with a smaller distance between them than the holes (1-B), allowing that in the formation of a chain, the interconnection between links, occurs in such a way that the end with the holes (1-B) of one link internally receives the end with the holes (1-A) of another link and, the end with the holes (1-A) of the same link is surrounded by the end with the holes (1-B) of another link, thus allowing a single link to be coupled in two different ways, to two different links and allowing the formation of a chain.

FIG. 4 details the bushing (3) with an internal hole (3-A) for pin insertion (4), it has a recess (3-B) at the ends to accommodate the sealing ring (2).

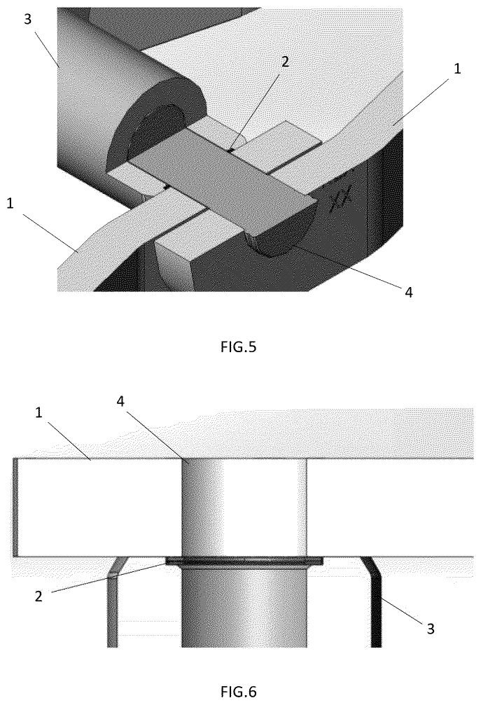

FIGS. 5 and 6 detail the positioning of the sealing ring (2) between the plate (1) and the bushing (3), more specifically involving the pin (4) next to the holes (1-A) and (3-A). When the ring (2) is pressed against the pin (4), it expands (the inner diameter of the ring is slightly smaller than the diameter of the pin, i.e., when the pin is introduced into the ring hole, it expands), ensuring the tightness of the inner part of the bushing (3-A) and lubrication retention.

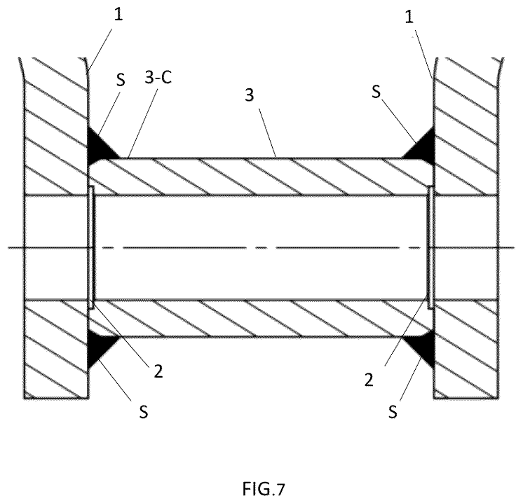

FIG. 7 details the weld bead(S) applied between the bushing (3) and the plates (1), fastening the parts to each other and enclosing the sealing ring (2). Thus, the weld is applied to the outside of the bushing (2), ensuring the lubrication of the link, preventing the entry of dirt and allowing the movement of the pin (4).

All structural components used in the links are made of steel alloy material, however, their manufacture is not limited to this. The material can be changed according to the need for chain traction.

The sealing ring (2) used next to the link must be made of an elastic material that allows the sealing and tightness of the joint, ensuring lubrication between pin (4) and bushing (3). For this, preferably as a ring (2) an elastic metal ring is used, called a spirolox ring. However, the ring (2) is not limited to this type of ring, and other types of elastic rings can be used to seal the link joint.

The welding of the link must be done after the seal (2) has been accommodated in the recess (3-B). The welding is applied to the external surface (3-C) of the bushing (3), fastening it next to the plate (1). While the inner part of the bushing (3) receives the pin (4) and is sealed by the sealing ring (2)

The application of the sealing ring (2) allows the contract region between bushing (3) and pin (4) to be lubricated, reducing the frictional effort between the parts and increasing their useful life. Preferably, lubrication is done through grease, however, any lubricant that reduces wear between parts can be used.

Optionally, the plates (1), bushing (3) and pin (4) receive heat treatment, such as quenching and tempering. More optionally, the carburizing treatment is carried out with the bushing (3) and induction with the pins (4).

Alternatively, the pins (4) are given a hard chrome surface treatment.

The welded chains formed by these links with inner seal can be composed of the number of links that are required according to their application, forming longer or shorter chains. The configuration of these links allows for greater versatility and longer useful life, as the inner sealing through the sealing ring (2) ensures that the useful life of the bushing (3) and pin (4) is much longer, through the application of lubricant.

This chain is usually connected to a conveyor belt and used for the transport of wood in the pulp and paper sector. However, its application can be in any technological sector that requires a chain for transporting materials.

1. A welded chain link with inner seal comprising two plates (1), a bushing (3) and a pin (4), with the plates (1) having holes (1-A) and (1-B) at their ends, characterized by:
next to the hole (1-A), on the inner side of the plate (1), a sealing ring (2) is applied between the bushing (3) and the plate (1);
the bushing (3) is welded through its outer surface (3-C) with the plate (1); and
said bushing (3) contains an internal hole (3-A) complementary to the hole (1-A) for inserting the pin (4).

2. The welded chain link with inner seal of claim 1, wherein bushing (3) with internal hole (3-A) for insertion of the pin (4), having a recess (3-B) at the ends for accommodating the sealing ring (2).

3. The welded chain link with inner seal claim 2, wherein the ring (2) comprises an elastic metal ring.

4. The welded chain link with inner seal of claim 1, wherein the plates (1), bushing (3) and pin (4) have been heat treated.
